(19) United States
(12) Patent Application Publication
(10) Pub. No.: US 2007/0031177 A1
(43) Pub. Date: Feb. 8, 2007

(54) PHARMACY SPATULA WRITING TOOL

(76) Inventor: Edward Haas, Champaign, IL (US)

Correspondence Address: MICHAEL BERNS;MALONEY, PARKINSON AND BERNS, 135 W MAIN STREET, URBANA, IL, 61801, US

(21) Appl. No.: 11/462,014

(22) Filed: Aug. 2, 2006

Related U.S. Application Data
(60) Provisional application No. 60/704,293, filed on Aug. 2, 2005.

(51) Int. Cl. B43K 29/00

(52) U.S. Cl. 401/195

(57) ABSTRACT

A pharmacy spatula tool incorporating a writing tool, such as a pen, pencil, highlighter, or other instrument.

### BACKGROUND OF THE INVENTION

The invention relates to an improved spatula for pharmacists to count pills or capsules. Pharmacists use a spatula to count pills for dispensing prescription medication. A pill tray is often used by pharmacists and their assistants to visually inspect and count out pills or capsules to be put into pill bottles. During this tasks, the pharmacist must frequently write information for their records or take notes. They must put down the spatula and pick up a writing instrument. This causes delays in filling prescriptions and opens the possibility of mistakes during usage.

### SUMMARY OF THE INVENTION

The present invention provides a pharmacy spatula with a writing instrument attached. The handle of a typical spatula is approximately four inches long. A writing instrument may be installed into the handle such that the user could turn the spatula over to write with the tool. This could be accomplished with one hand and eliminate the need for switching back and forth between the spatula and the writing instrument.

### DESCRIPTION OF THE DRAWINGS

FIG. 1 is a rendering of an embodiment of the invention having a retractable pen.

FIG. 2 is a rendering of an embodiment of the invention having a fixed writing instrument.

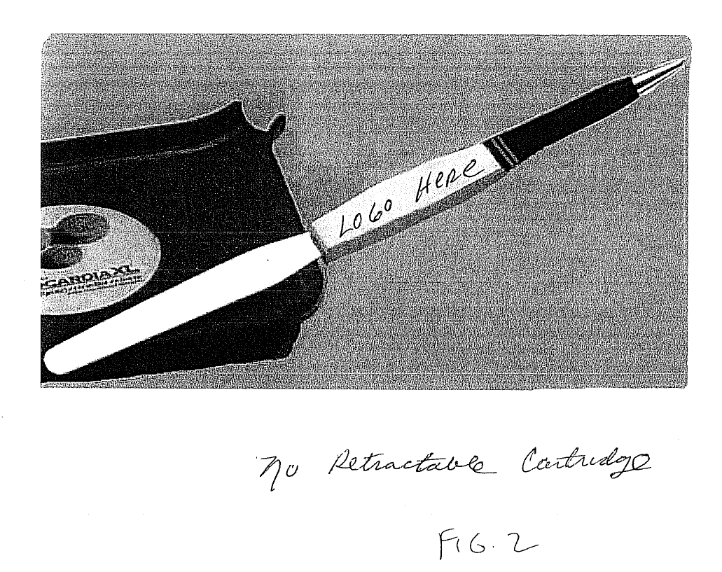

### DETAILED DESCRIPTION OF THE INVENTION

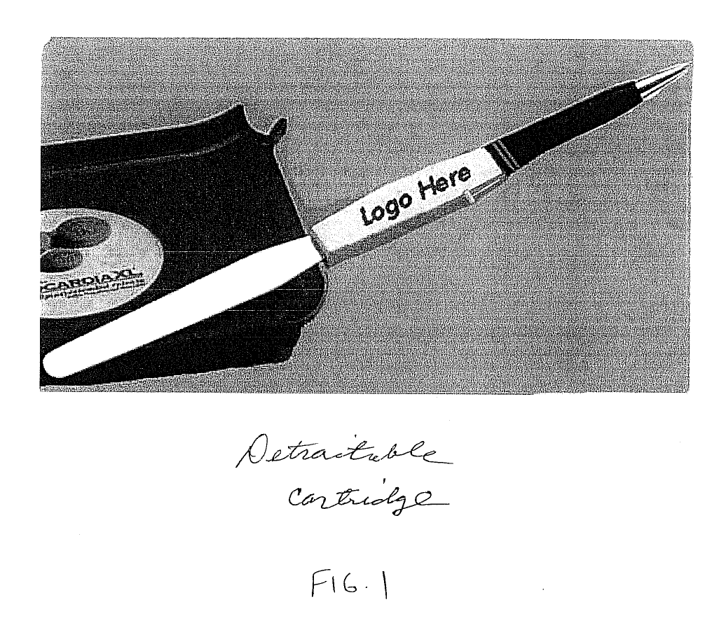

Referring to FIG. 1, a pharmacy spatula blade 1 is attached to an elongated handle 2 having a first end attached to the spatula blade 1 and a second end having a writing instrument 3.

The writing instrument 3 may be a pen, pencil, stylus, or other device for recording information. The writing tip of the writing instrument may be provided with a retractable feature to allow the writing tip to recess into the handle 2, or have a twist-up or other means of recessing the writing tip into the handle 2 of the device to prevent accidental marking. A cap may also be provided to cover the writing tip of the writing instrument 3.

The device of the invention provides a suitable location for advertising. Drug manufacturers and other advertisers may wish to have a location that is frequently accessible to pharmacists, or their assistants. Indicia 4 may be placed on the handle 2 or writing instrument 3.

The foregoing description of the preferred embodiments of the present invention. Various modifications and alternatives within the scope of the invention will be readily apparent to one of ordinary skill in the art.

I claim:

1. A pharmacy spatula having a first and second end, wherein the first end includes a spatula for counting pills, and the second end includes a writing tool.

2. The pharmacy spatula according to claim 1, wherein the writing tool comprises a pen.

3. The pharmacy spatula according to claim 1, wherein the writing tool comprises a pencil.

4. The pharmacy spatula according to claim 1, wherein the writing tool comprises a highlighter.

5. A pharmacy spatula comprising a spatula, including a handle, and a writing tool attached to the handle.

5. The pharmacy spatula according to claim 5, wherein the writing tool is attached to the handle such that a user may hold the handle to use the spatula, then rotate the pharmacy spatula to use the writing tool.

6. The pharmacy spatula according to claim 5, wherein the writing tool comprises a pen.

7. The pharmacy spatula according to claim 5, wherein the writing tool comprises a pencil.

8. The pharmacy spatula according to claim 5, wherein the writing tool comprises a highlighter.
